(19) United States
(12) Patent Application Publication
(10) Pub. No.: US 2020/0020010 A1
(43) Pub. Date: Jan. 16, 2020

(54) Digital Advisor

(71) Applicant: Robert D. Fish, Irvine, CA (US)

(72) Inventor: Robert D. Fish, Irvine, CA (US)

(21) Appl. No.: 16/582,782

(22) Filed: Sep. 25, 2019

Related U.S. Application Data
(62) Division of application No. 14/015,163, filed on Aug. 30, 2013.
(60) Provisional application No. 61/697,185, filed on Sep. 5, 2012.

(51) Int. Cl. G06Q 30/06

(52) U.S. Cl. CPC G06Q 30/0609

(57) ABSTRACT

A cell phone, tablet, laptop, TV or other device is configured to provide comments with respect to a user's prospective selection of a media item, a physical object, a service, or anything else. Comments are derived from user-specific preference information, (including e.g., selection history, rationale for prior selections, analysis of stored images, and persona), and can optionally be derived from comment templates. Comments are preferably made in a second person grammatical form, can be humorous, and can include derogatory remarks about a prospective selection and/or the user.

This application is a Divisional of and claims priority to U.S. application Ser. No. 14/015,163 filed Aug. 30, 2013, which claims priority to U.S. provisional patent application No. 61/697,185, filed Sep. 5, 2012, both of which are incorporated herein by reference in their entirety.

### FIELD OF THE INVENTION

The field of the invention is electronic commerce.

### BACKGROUND

Given the vast array of information currently available on the Internet, and through newspapers and other sources, it can be very difficult for an individual to make intelligent choices as to media items (movies, music, etc), physical items (cars, computers, TV sets, etc) and services (plumbers, doctors, etc). There are, of course, numerous websites and blogs comparing the benefits of this or that offering, but many of them are merely self-serving advertisements. And as pointed out in the July 2012 book, Trust Me I'm Lying by Ryan Holiday, much of the information might be unreliable, or even completely fabricated.

Search engine listings are not particularly helpful in cutting through the noise. Under Google's™ AdSense™ revenue and similar models, the advertisements presented to users are ranked according to which advertisers pay the most money to “buy” keywords. And even the regular listings are gamed, with the top-ranked web pages being determined in large measure by how cleverly the web site owners are able to manipulate the rankings. Crowd-sourcing sites such as www.angieslist.com can be somewhat helpful by summarizing views of numerous individuals. But such sites can also be gamed.

Another problem for users in making selections that utilize existing technologies is that any guidance given to users tends to be quite impersonal. Some sites, such as www.Amazon.com, do a reasonably good job of using historical information to guide users, and in that sense personalize the guidance to some extent. But even there the guidance is presented in an impersonal, third-person manner, along the lines of “Those who liked . . . also like . . . .”

Still another problem with the known systems and methods for guiding users is that the guidance is made before the user has made a prospective selection. Once the user has made a prospective selection, the currently known systems and methods are only concerned with how many, cost, shipping details, disclaimers as to safety, and the like. There are no personalized comments regarding whether that prospective selection would be appropriate for that particular user.

What is needed is something more like a personal shopper, a device that interacts with a person to discover personal preferences, and then to provide a personalized comment with respect to whether a prospective selection would be appropriate for that particular user. And what would be especially desirable is for a device that interacts with the person in a conversational manner, commenting on potential purchases and perhaps other interests, and at times injecting humorous and/or negative comments into the conversation.

### SUMMARY OF THE INVENTION

The inventive subject matter provides apparatus, systems and methods in which a server, and/or a cell phone, tablet, laptop, TV, media player or other device that might or might not be cooperating with a server, is configured to provide a personalized comment in response to a user's prospective selection of a media item, a physical object, a service item, an idea item, or anything else.

As used herein, unless the context indicates otherwise, the term “comment” should be interpreted broadly to include all manner of comments, including, for example, full or partial declaratory sentences, questions, and quips.

Also, unless the context indicates otherwise, the terms “individual” “user”, and “person” should all be interpreted interchangeably herein to include live human beings, thinking machines, and virtual and mixed-reality beings.

Still further, unless the context indicates otherwise, the term “prospective selection” means that the user has indicated an interest in an item, but has not yet consummated an interaction with respect to that item. The term “interaction” includes “transactions”, in which a right, title, or possession of an item is transferred. Contemplated financial transactions include purchasing, renting, selling, leasing, etc where money or money equivalents is involved. Contemplated non-financial transactions include, for example, borrowing a car, in which no money or money equivalents changes hands. The term “interaction” also includes non-transaction things, as for example reading, speaking, listening, using, posting, and so forth.

As used herein, the term “personalized comment” refers to a comment that differs according to preferences or other information on a person-to-person basis. To illustrate this distinction, every person buying certain nutraceutical supplements from www.iherb.com will be shown a “California Prop 65 Warning.” The same warning will be applied to every prospective such person, regardless of that person's preferences or buying history.

A user's “prospective selection” of an item can be made in any suitable manner, including pointing to or mousing over a display of choices, and making an audible selection (e.g., “I would like to buy the red one.”) Surfing of prospective items could be in a physical store, electronic store, or even stored in a virtual Second Life™ type of store, or in a mixed-reality environment.

The term “items” includes anything upon which a selection can be made. This includes living, dead, or inanimate physical objects in the real world, as well as living, dead, or inanimate objects in a virtual or mixed-reality environment. This also includes services, and non-physical things, in the real world or elsewhere, such as ideas, thoughts, and concepts.

In some preferred embodiments, the personalized comments are user-specific in that they address suitability of a specific item for a specific user. Such user-specificity is preferably derived from historically available information, including for example, the user's selection history, the user's rationale for making prior selections, and analysis of the user's viewed or stored images.

Additionally or alternatively, user-specificity of the comments can be derived from consideration of one or more circumstances of the user when the comment is being created (de novo or modified from a pre-existing comment). Circumstances that can be used for that purpose include time, date, location of the user, surroundings of the user (mode of transportation, car, train, etc, noise level, rain, temp, building, privacy, friends, strangers, etc), body parameter of the user (approximate or estimated blood pressure, pulse, temp, etc), and one or more of the user's personas (e.g., where the user is currently operating as a employee, mother, friend, etc).

Personas used in connection with crowd-sourced databases are described in one of my pending patent applications, US2008/0097849 (Ramsaier et al., publ. April 2008). In the context of the current application, personas could be used to modify the weighting given to previously stored preference information for a user.

US2008/0097849, as well as all other extrinsic materials discussed herein, is incorporated by reference in their entirety. Where a definition or use of a term in an incorporated reference is inconsistent or contrary to the definition of that term provided herein, the definition of that term provided herein applies and the definition of that term in the reference does not apply.

User-specific comments are preferably constructed using comment templates, and preferably utilize a second person grammatical form (e.g., “you wouldn't like that movie”), as opposed to generic comments such as “others who like . . . also like . . . .” Contemplated comments can be humorous, and can include derogatory remarks about a prospective selection and/or the user. Comments are preferably rendered in audible speech, but can also be rendered as text, and/or images or other non-verbal formats.

Even though user-specific comments are generated for a particular user with respect to a particular item, and possibly with respect to a particular circumstance, user-specific comments need not be, and often will not be, unique. For example, it is entirely possible that two different individuals, or a single individual at two different times, might be given the same comment “Good choice, Mary”, or “No way. You won't like that at all.”

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a schematic of a user interfacing with various devices to make prospective choices and receive comments.

FIG. 2 is a schematic of a database table that could be used to store preference information about a user.

FIG. 3 is a schematic of a database table containing templates for the text or audible speech provided to users.

### DETAILED DESCRIPTION

The following discussion provides example embodiments of aspects of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention, and does not pose a limitation on the scope of the invention otherwise claimed. No language in the specification should be construed as indicating any non-claimed element essential to the practice of the invention.

Throughout the discussion, references may be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

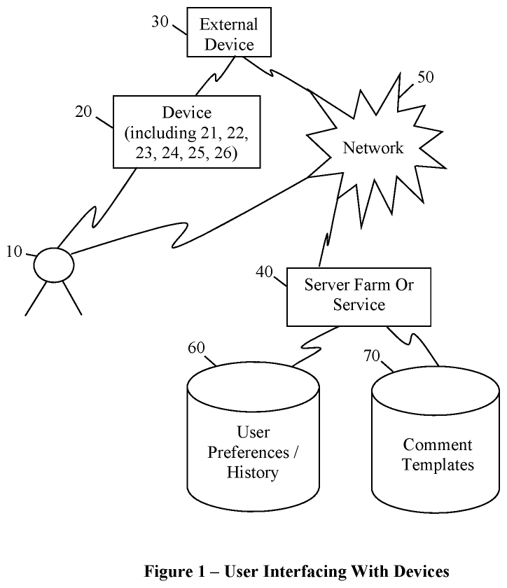

In FIG. 1 a person 10 is holding a portable device 20 having a housing 21, within which is disposed first electronics 21 capable of conducting cell phone calls, and second electronics capable of communicating audibly and tactually with the person, and digitally with an external service. Device 20 also includes a visual display 23, a speaker 24, a memory 25, and a microphone 26, and is programmed to operate as a media player. FIG. 1 should be interpreted as showing the person 10 speaking into, or operating a finger upon the visual display 23, to indicate a prospective selection of an item.

In FIG. 1 the device 20 is communicating with an external device 30, which should be interpreted generically to include any device (or plurality of devices) that could be controlled by device 20. All practical means of control are contemplated, including direct wired and wireless communication, by tactual input (e.g., pushing on a button as with a TV remote control) as well as by voice commands (e.g., using a translation service as taught by U.S. Pat. No. 8,165,867 (Fish, 2012), and US2012/0310623 (Fish, publ, 12/212). Device 30 should be interpreted as including any of a television set (TV), with or without a separate digital video recorder (DVR) or set-top box, a household appliance such as a distally controllable dishwasher, security system, thermostat, or garage door opener, and a cell phone, a local or distal computer, etc.

As used herein, the term “distally” and “distal” refer to things that are (in the real world) or appear to the user to be (in a virtual or mixed reality environment) at least 1000 meters away.

FIG. 1 also depicts a network 40 through which device 20, operating directly or through device 30, can access a server farm or service 50. Server farm or service 50 stores and retrieves data from a user preferences database 60 and a comments template database 70, and in preferred embodiments generates comments passed back to the user 10 based in part on the user's potential selection of an item.

It should be noted that while the description herein is drawn to a client/server type architecture, where the client is the device 20 or the device 30, and the server is the server farm or service 50, various alternative configurations are also deemed suitable, and may employ various computing devices including cloud-based servers, interfaces, systems, databases, agents, peers, engines, controllers, or other types of computing devices operating individually or collectively.

Moreover, each of the computing devices of FIG. 1 should be interpreted as comprising a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

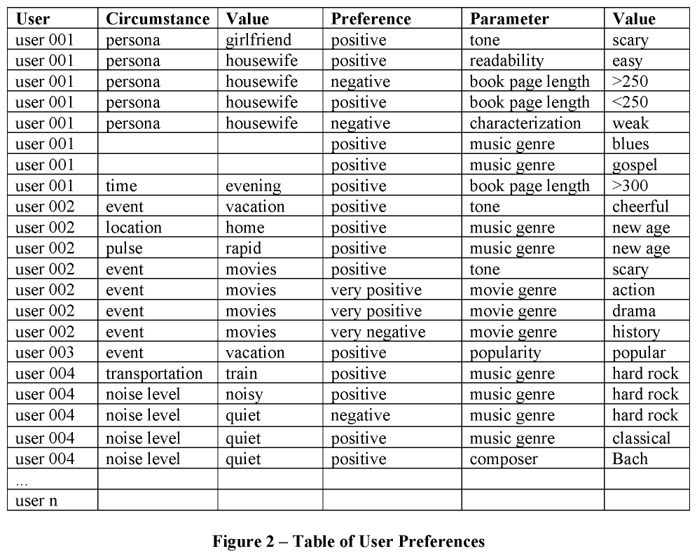

FIG. 2 is a schematic of a database table that could be used to store preference information about users. As currently envisioned a single flat table holds both circumstances and related preferences, but XML and any other data structure that serves the purposes described herein are also contemplated. Record numbers and other linked tables, perhaps those listing the possible choices for circumstances and parameters, are hidden for simplicity of presentation, but should be interpreted as being included.

The reader should appreciate that not every user has an entry for every type of circumstance or parameter. For example, user 001 has different preferences (positive and negative) for books depending on whether the person is in her housewife persona, or in a girlfriend persona. User 002, on the other hand, has not recorded any information regarding personas.

It should also be apparent that some entries can be literally or effectively redundant. For example, user 001 in the housewife persona dislikes books more than 250 pages, and in the same persona tends to like books less than 250 pages. That information is substantially redundant. User 001 also likes books with more than 300 pages in the evening, which could be construed as either being consistent or inconsistent with disliking books dislikes books more than 250 pages in her housewife persona. Unless the context dictates the contrary, all ranges set forth herein should be interpreted as being inclusive of their end points, and open-ended ranges should be interpreted to include commercially practical values. Similarly, all lists of values should be considered as inclusive of intermediate values unless the context indicates the contrary.

Still further, it should be appreciated that not all records need to have an entry for circumstance. In such cases the record is preferably interpreted as applying to all circumstances. Although records can have preferences without associated circumstances, it is not particularly useful to have a circumstance without a preference.

Information relating to all relevant types of circumstances is contemplated. Among other things, contemplated circumstances include time, date, or location of the user, surroundings of the user (mode of transportation, car, train, etc, noise level, rain, temp, building, privacy, friends, strangers, etc), body parameter of the user (blood pressure, pulse, temp, etc), and persona of the user (e.g., employee, mother, friend, etc).

In preferred embodiments, preferences are stored as tautologies, and most preferably as dichotomies, i.e., positive or negative, plus or minus, 1 or zero, like or dislike, etc. In other embodiments, for example as depicted in FIG. 2, preferences could be more nuanced. Preferences in such instances could be a range, as in −5 to +5, or 1 to 10, or very negative to very positive, or something along the lines of Fandango's™ rating system, Oh no!, Don't Go, Go, and Must See.

User preference information included in a table such as that of FIG. 2 is can be derived from any suitable source or combination of sources, but is preferably obtained directly through one or more conversations with the user. Following is a contemplated such conversation, triggered by the user selecting a Harry Potter book for purchase.

System: Is this ______ for you?

User: For me.

System: Your previous purchases have been historical novels. Why Harry Potter?

User: It's very popular.

System: Is it fair to say that you have a preference for books that are popular?

User: Yes.

System: Is there a particular circumstance in which you like books that are popular?

User: Yes. When I'm on vacation.

From that interchange the system can store a record showing that user 003 likes to read popular books when on vacation. (see FIG. 2).

As used herein, the term “conversation” means a verbal exchange in a human language (whether conducted auditorily, in written text, or otherwise, and whether or not it also includes images, symbols, links or other information outside the scope of human language), in which there is at least a first comment, a response to the first comment, and a response to the earlier response. Preferred conversations include at least one question and an answer to that question, and more preferred conversations include at least two questions.

Thus, if an entire exchange consists of “Please make a selection” and “I choose the apple”, the exchange is not considered a conversation herein because there is no second response.

Similarly, in the prior art it is known for a user to access an Internet web site to purchase an item. The website provides a search window, into which the user enters various search terms. An instruction to “Please enter search terms” is a first comment, and entry of a search term is a response to that first comment.

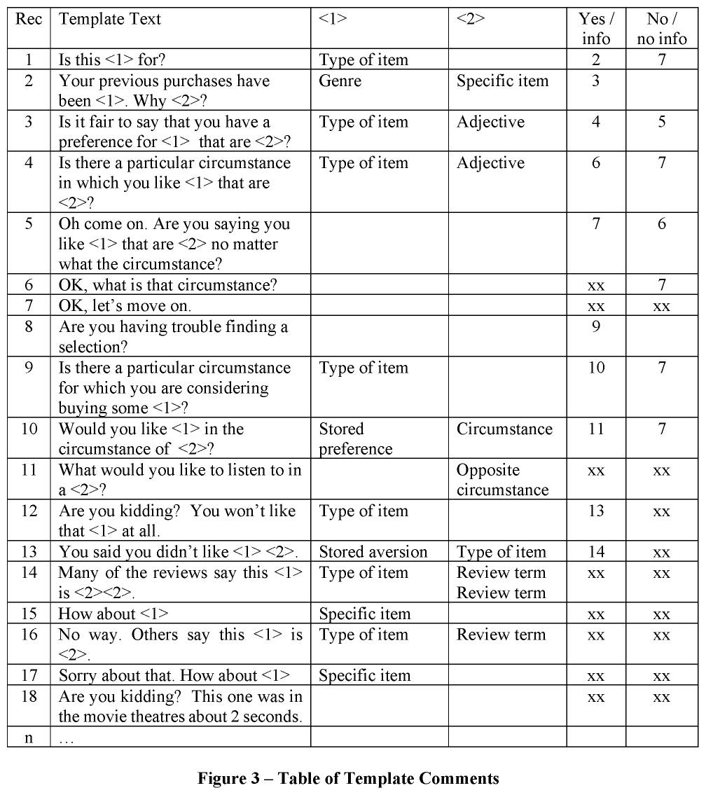

FIG. 3 is a schematic of a database table containing templates for the text or audible speech provided to users. Column 1 is record number. Column 2 contains language for the text/speech of a comment, with <x>denoting fill-in-the-blank information. Columns 3-5 describe what information should be included in the blanks. Columns 6 and 7 depict logic branches. In the example above, the user answered either “yes” or provided substantive information so branching went to the listed template comment. If the user has said “no” to the question derived from template 3, the logic would have branched to record 5 in this particular example. The “xx” in Table 3 indicates logical branching to other records that are not shown.

To keep conversations interesting to users, additional tables (not shown) and semantic algorithms can be used to vary the comments. For example, in record 3 a language varying algorithm might sometime substitute the word “reasonable” for the word “fair”. There can also be additional tables (not shown) and other semantic algorithms that can interpret responses other than “yes” and “no”. For example, the words/terms “sure”, “of course”, and “you bet you” could all be interpreted by the system as “yes”.

Those skilled in the art will appreciate that the sort of computer-directed conversational interaction with user involves many other artificial intelligence aspects, including language parsing and use of grammar rules. Other than what is taught herein, those aspects, routines and features are all considered to be part of the prior art.

Here's another contemplated interaction, initiated when the user has spent several minutes surfing without buying anything:

System: Are you having trouble finding a selection?

User: Yes I am.

System: Is there a particular circumstance for which you are considering buying some music?

User: Yes, I want something loud for use on a noisy train.

System: Would you like hard rock in the circumstance of a noisy train?

User: Yes.

System: What would you like to listen to in a quiet environment?

User: I would like classical music such as Bach.

From that interchange the system could store the entries shown in FIG. 2 for user 004.

Here's another contemplated interaction, initiated when the user has selected a particular movie to rent.

System: Are you kidding? You won't like that movie at all.

User: Why not?

System: You said you didn't like scary movies.

User: Oh, I didn't know that one is scary.

System: Reviews say this movie is really scary, and oh my God scary.

This example is interesting in that the first comment, “Are you kidding . . . ”, is intended to be humorous, or at least jocular. In addition, the user response is not simply “yes” or “no”, but is interpreted as providing a substantive response, which triggers the comment of record 13. Similarly, “Oh, I didn't know that one is scary” is interpreted as being a substantive response that triggers the comment of record 14. In another interesting aspect, the record 14 instructs the system to include two review items in the comment delivered to the user.

As should be apparent from the discussion above, user-specific comments are preferably constructed using comment templates, and utilize a second person grammatical form (e.g., “you wouldn't like that movie”), as opposed to generic comments such as “others who like . . . also like . . . ” Contemplated comments can be humorous, and can include derogatory remarks about a prospective selection and/or the user. Comments are preferably rendered in audible speech, but can also be rendered as text, and/or images or other non-verbal formats.

Second person grammatical form should be interpreted herein as including standard, colloquial and archaic forms, in any language. In English this includes singular forms, you, and thou, and plural forms you, youse, ye, you guys, and y'all.

Although preference information is preferably gleaned directly from users, other information can be derived from user reviews, either those stored by the system, or reviews taken from elsewhere. For example, it is contemplated that the system could scrape text from Fandango™ reviews for movies, and web sites such as Amazon™ and eBay™ for movies, books, furniture, cars, electronics and other items.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A system comprising an electronic device programmed to assist a user in making a purchasing decision regarding a prospective purchase using the following steps, in sequence:
receive a rationale information from the user with respect to a prior purchase decision;
receive a request from the user to execute the prospective purchase; and
utilize the rationale information to take a step to prevent the user from executing the prospective purchase.

2. The system of claim 1, wherein the step to prevent the user from executing the prospective purchase prevents the user from executing the prospective purchase.

3. The system of claim 1, wherein the step to prevent the user from executing the prospective purchase comprises delaying the prospective purchase.

4. The system of claim 1, wherein the step to prevent the user from executing the prospective purchase comprises the device initiating a conversation with the user about the prospective purchase.

5. The system of claim 1, wherein the step to prevent the user from executing the prospective purchase comprises preventing the user from making a mistaken purchase.

6. The system of claim 1, wherein the rationale information is associated with a persona characteristic submitted by the user.

7. The system of claim 1, wherein the rationale information is derived at least in part from a plurality of prior purchase decisions made by the user.

8. The system of claim 1, wherein the rationale information is derived at least in part from the electronic device asking the user why the user made the prior purchase decision.

9. The system of claim 1, wherein the prospective selection is ascertained at least in part by an unsolicited audible conversation with the user initiated by the electronic device.

10. The system of claim 6, wherein the persona is associated with a present circumstance selected by the electronic device.

11. The system of claim 1, wherein the step of receiving the rationale information from the user comprises a comparison of a first and second prior purchase decision by the user and asking the user about the comparison.

12. The system of claim 1, further comprising a step of answering a question of the user regarding the step to prevent the user from executing the prospective purchase.

13. The system of claim 1, wherein the step to prevent the user from executing the prospective purchase further comprises consideration of a present circumstance of the user, wherein the present circumstance is selected from the list consisting of a time, a date, a location of the user, surroundings of the user, a body parameter of the user, and a persona of the user.

14. The system of claim 1, wherein the step to prevent the user from executing the prospective purchase comprises telling the user the prospective purchase is inconsistent with the rationale information.

15. A media player operable by a human user, comprising:
a processor configured to render a prospective media choice to the user;
the processor further configured to receive a rationale information from the user with respect to a prior media choice; and
the processor further configured to take a step to prevent the user from executing the prospective media choice;
wherein the step to prevent the user from executing the prospective media choice is derived at least in part from a comparison of the rationale information and the prospective media choice.

16. The media player of claim 15, wherein the processor is further configured to receive a response from the user regarding the step to prevent the user from executing the prospective media choice.

17. The media player of claim 15, wherein the step to prevent the user from executing the prospective media choice comprises audibly telling the user the prospective media choice contradicts the rationale information.

18. The media player of claim 15, wherein the step to prevent the user from executing the prospective media choice prevents the user from executing the prospective media choice.

19. The media player of claim 15, wherein the step to prevent the user from executing the prospective media choice comprises the media player initiating a conversation with the user about the prospective media choice.

20. The media player of claim 15, wherein the processor is further configured to receive a persona selected by the user, and wherein the persona is associated with the rationale information.
